(19) United States
(12) Patent Application Publication
(10) Pub. No.: US 2002/0046250 A1
(43) Pub. Date: Apr. 18, 2002

(54) Certified and registered electronic mail system

(76) Inventor: Nick Nassiri, Los Angeles, CA (US)

Correspondence Address: Nick Nassiri, #650, 11222 La Cienega Blvd., Inglewood, CA, 90292, US

(21) Appl. No.: 09/982,145

(22) Filed: Oct. 17, 2001

Related U.S. Application Data
(60) Provisional application No. 60/241,235, filed on Oct. 17, 2000.

(51) Int. Cl. G06F 15/16

(52) U.S. Cl. 709/206

(57) ABSTRACT

A method, program and system to verify that an electronic message was sent to the intended recipient and to provide the originator of the electronic message with an independent confirmation that verifies the time and date that the electronic message was sent and the time and date that it was delivered. A secondary purpose is to verify the identity of an intended electronic mail recipient prior to the intended recipient's receipt of the electronic mail. The inventive device includes a central processing unit to facilitate the receipt and delivery and confirmation of electronic mail. The processing unit tracks incoming and outgoing electronic messages; tracks customer accounts and identities; archives all relevant information for future use and/or reference; and disseminates the foregoing data to regional/local servers and clients as necessary.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### BACKGROUND OF THE INVENTION

### Field of the Invention

The present invention relates generally to the field of electronic mail and more specifically it relates to a method, program and system to independently verify that an electronic message was sent to the intended recipient and to provide the original sender of the electronic message with verification of the time and date that the electronic message was sent.

Parent Case Text

This U.S. patent application claims the priority of U.S. Provisional Patent Application No. 60/241235 filed on Oct. 17, 2000 entitled, “Certified and Registered Electronic Mail System” by the same inventor.

Description of the Prior Art

It can be appreciated that various methods of verifying the delivery of electronic mail have been in use. Typically, methods of email verification are comprised of electronic mail processing systems that track the path of the electronic messages. The Prior Art establishes that the tracking of electronic mail in and of itself is not a novel idea; however, existing electronic mail solutions fail to offer customized delivery verification or verification of recipient identity prior to receipt of the electronic message, as contemplated by the method and system of the present invention.

By way of example, the present invention comprises a method and system whereby the sender of an email can have an independent authority confirm the time and date that an email was delivered to the intended recipient and the time and date that an email was received by an intended recipient. Too, the present inventive device comprises a method and system whereby the sender of an email may request the identity of the intended recipient is confirmed by an independent authority prior to the intended recipient receiving the electronic message.

The prior art discloses U.S. Pat. No. 6,282,565 entitled “Method and apparatus for performing enterprise email management” issued to Shaw et al; U.S. Pat. No. 6,108,688 entitled “System for reminding a sender of an email if recipient of the email does not respond by a selected time set by the sender” issued to Nielson; U.S. Pat. No. 5,878,230 entitled “System for email messages wherein the sender designates whether the recipient replies or forwards to addresses also designated by the sender” issued to Weber, et al; and U.S. Pat. No. 5,694,616 entitled “Method and system for prioritization of email items by selectively associating priority attribute with at least one and fewer than all of the recipients” issued to Johnson, et al.

The Shaw patent discloses an “enterprise” email system which is designed chiefly to process large volumes of email quickly and efficiently. The enterprise email system processes incoming email using a set of configurable rules that examine incoming messages for a specific attribute state condition and subsequently invoke a configurable action when the attribute satisfies the condition. The enterprise email system assigns a mail queue timer when a message is moved into a mail queue. Each mail queue has a different mail queue timeout value that specifies the maximum amount of time that a message may sit idle within a mail queue. The enterprise email system may automatically move a message from a mail queue into a mailbox of an enterprise email system user that subscribed to the mail queue. If the mail queue timer expires, then the message is routed to another mail queue or enterprise email user. The Shaw patent does not depict a method and system of customized email delivery verification or verification of an email recipient identity prior to receipt of the electronic message by the recipient from the sender.

The Nielson patent discloses a system for warning the sender of an email message if the message is not received. The Nielson system permits the sender of a message to designate whether the sender wishes to be warned in case the message is not opened by the recipient prior to a time and date specified by the sender. The sender's system maintains a database of such messages, and automatically monitors incoming messages and updates the database as responses are received from recipients of messages. If a response is not received from a recipient prior to the specified date, the system generates a warning message to the sender. The Nielson patent does not depict a method and system of customized email delivery verification or verification of an email recipient identity prior to receipt of the electronic message by the recipient from the sender.

The Weber patent discloses an electronic mail network, the electronic mail network further comprises a plurality of nodes or computer stations that permit an email message sender to control down stream routing of the message. The system enables the sender of a message to specify which addresses should automatically be set when a recipient of the message replies to or forwards the message. The Weber patent enables the originator of an email distribution to specify one or more recipients in a reply address field as the destination whenever the recipient replies to the note. By way of example, User A sends a note to User B and designates User C in the reply address field. In the note, User A asks User B to reply with an answer to User C. User B reads the note, then selects the reply function. The system then automatically fills in the reply destination address field of User C. The Weber patent does not depict a method and system of customized email delivery verification or verification of an email recipient identity prior to receipt of the electronic message by the recipient from the sender.

The Johnson patent discloses a method and system for the prioritization of the display order of received electronic email items. In one embodiment, the invention associates a priority sorting attribute with a first email item, sorts an in-basket list of email items by any priority sorting attribute associated with any email item in the in-basket list, said in-basket list including a listing for the first email item, and displays at least a portion of the sorted in-basket list in the sorted order. The priority sorting attribute may be associated with the first email item by either the sender or the receiver of the first email item.

A priority sorting attribute may be associated by the sender with some but not all of the intended recipients of the first email item and the priority sorting attribute will then be associated with the first email item only as it is sent to those recipients with whom the priority sorting attribute has been associated. The Johnson patent does not depict a method and system of customized email delivery verification or verification of an email recipient identity prior to receipt of the electronic message by the recipient from the sender.

The main problem with conventional methods of email prioritization systems is that none of the prior art has a method, system or process whereby the sender of an electronic message (hereinafter the “Client”) can request that an independent, third-party (hereinafter the “Processing Unit”) re-send an electronic message in order to establish a secondary, verified, registered and archived record of the time and date the electronic message was sent to the recipient.

Another problem with conventional method of email prioritization systems is that current methods, systems or processes do not automatically notify the sender of an electronic message when the message was sent by the sender, but rather confirms when the email was received. (i.e., the equivalent of an electronic “return receipt”). There exists a need, from the standpoint of the message sender, to ascertain the exact time and date an electronic mail was sent. In an internet based, e-commerce environment, numerous contractual arrangements are dependent on establishing the precise time and date of not only receipt of an electronic message, but also the time and date that the message was sent to the intended recipient by the sender. In the event of dispute resolution, verification of such delivery information is of critical importance.

Another problem with conventional methods of email prioritization systems is that none of the prior art discloses a method, system or process whereby the sender or another authorized party is able to access verified, archived electronic mail information for future use and in the event of dispute resolution. There exists a need to have an independent, neutral authority that can verify the time and date that an email message was sent to the intended recipient. Likewise, there exists a need whereby an independent third party can verify the message content, including attachments, of an electronic message in the event of dispute resolution.

Another problem with conventional method of email prioritization systems is that none of the prior art discloses a method, system or process for tracking the time and date an email was sent that is user friendly. Conventional methods of tracking the time and date of delivery are beyond the technical ability of many lay people. The traditional methods of tracking electronic mail are comprised of complicated, technically laden, messages or confirmations that are generated internally by the electronic mail server. Such messages or confirmations are often beyond the ability of a lay person to access or to understand, and as such there exists a need for an independent authority to confirm when the electronic message was sent.

Another problem with conventional methods of email prioritization systems is there exists no process or method whereby the sender can send an electronic message to an independent processing unit to “hold” the electronic message pending verification of the intended recipient's identity by the processing unit. Upon confirmation, the electronic message is released to the recipient and the sender is notified.

Another problem with conventional methods of email prioritization systems is there exists no process or method whereby the sender can send an electronic message to a processing unit that in turn will send the electronic message on the client's behalf thereby rendering the client's identity as anonymous.

While the devices of the prior art may be suitable for the particular purpose to which they address, they are not as suitable for a method, program and system to certify that an electronic message was sent to the intended recipient and to provide the sender of the electronic message with the time and date that the electronic message was sent.

The present inventive device is distinct from the prior art because it acts as an independent, verification that the e-mail was sent; said confirmation is achieved by the invention sending the e-mail message on behalf of the sender, tracking the electronic mail routing, and providing the client with a digital certificate that verifies the time and date when the electronic message was sent, and when it was received.

In these respects, the certified and registered electronic mail method and system according to the present invention, substantially departs from the conventional concepts and designs of the prior art, and in so doing provides an apparatus primarily developed for the purpose of a method, program and system to verify that an electronic message was sent to the intended recipient and to provide the sender of the electronic message with a digital certificate that independently verifies the time and date that the electronic message was sent, and if needed, a confirmation of the intended recipient's identity prior to receipt of the electronic message.

### SUMMARY OF THE INVENTION

In view of the foregoing disadvantages inherent in the known types of method of email verification now present in the prior art, the present invention provides a new certified and registered electronic mail system construction wherein the same can be utilized for a method, program and system to verify that an electronic message was mailed to the intended recipient and to provide the sender of the electronic message with a digital certificate that independently verifies the time and date that the electronic message was sent, and of the intended recipient's identity, if needed.

The general purpose of the present invention, which will be described subsequently in greater detail, is to provide a new electronic mail system that has many of the advantages of the method of email verification mentioned heretofore and many novel features that result in a new certified and registered electronic mail system which is not anticipated, rendered obvious, suggested, or even implied by any of the prior art method of email verification, either alone or in any combination thereof.

A secondary purpose is to verify the identity of an intended electronic mail recipient prior to the intended recipient's receipt of the electronic mail by an independent authority.

To attain the above identified purposes, the present invention generally comprises a method, system and process for receiving and sending, and confirming and registering, electronic mail sent over the internet, computer networks, satellite or other systems that facilitate electronic messaging; and a method, system and process for verifying the identity of an intended recipient of an electronic mail prior to delivery of the electronic message. The latter described method uses a central processing unit to facilitate the receipt and delivery and confirmation of electronic mail, and an infrastructure that facilitates the receipt and delivery and confirmation of electronic mail.

The present invention satisfies a need in the marketplace for users of electronic messaging to utilize an independent authority (the “Processing Unit”) to “register” or “certify” electronic mail communications. The present invention satisfies a need in the marketplace for users of electronic messaging to utilize an independent authority (the “Processing Unit”) to verify the intended recipient of an electronic mail communication, prior to receiving it. In either instance, the Client interfaces with the Processing Unit by way of a local computer system and the internet to tender a request.

A request for registered or certified mail entails the Processing Unit sending the electronic message, and any attachments thereto, independent of the Client to the intended recipient. The Processing Unit, notifies the Client of when the electronic message was sent, and if requested, when it was received. Notification typically comprises a digital certificate that is emailed to the Client. If requested, the processing Unit retains a copy of the message contents, including any attachments, for future reference. In any event, the Processing Unit retains a record of the time and date the message was sent and when it was delivered for future reference.

A request for identity verification prior to the receipt of registered or certified mail entails the Processing Unit contacting the intended recipient prior to sending the electronic message, and any attachments thereto. The Processing Unit verifies that the email account to which the electronic message is to be routed corresponds to the identity of an intended recipient, prior to sending the electronic message. Alternatively, the Processing Unit may hold an electronic message on behalf of the sender, whereby the intended recipient is verified in person at a service center maintained by the present invention. Upon verification of the recipient's identity, the Processing Unit notifies the Client of when the electronic message was delivered to the intended recipient. Notification typically comprises a digital certificate that is emailed to the Client. If requested, the processing Unit retains a copy of the message contents, including any attachments, for future reference. In any event, the Processing Unit retains a record of the time and date the message was sent and when it was delivered for future reference.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a certified and registered electronic mail system that will overcome the shortcomings of the prior art devices.

Another object of the present invention is to provide a certified and registered electronic mail system that will notify the sender of an electronic message through an independent processing unit (i.e., not the equivalent of a “return receipt” that is generated from the sender's own email server) that the electronic message was sent to the recipient and the time and date thereof. Said confirmation typically will be in the form of a digital certificate that is archived for future use.

Another object of the present invention is to provide a certified and registered electronic mail system that will allow the sender of an electronic message to forward the message to an independent processing center that will in turn deliver the message on behalf of the sender without identifying the Client. Said Client shall remain anonymous in this transaction but will receive confirmation of the time and date the electronic message was sent, typically in the form of a digital certificate from the Processing Unit.

Another object of the present invention is to provide a certified and registered electronic mail system that will allow the sender of an electronic email to forward the electronic message to the processing center to hold on behalf of the sender, pending verification of the intended recipient's identity. Upon verification of the intended recipient's identity, the processing center will deliver the electronic message to the intended recipient and send a confirmation of the time and date thereof via digital certificate to the Client.

Another object of the present invention is to provide a certified and registered electronic mail system that will interface with the patent pending technology as identified in USPTO customer number 021907.

Another object of the present invention is to provide a certified and registered electronic mail system that establishes an archive system that stores the records described herein for future retrieval if necessary.

Other objects and advantages of the present invention will become obvious to the reader and it is intended that these objects and advantages are within the scope of the present invention. Specifically, with reference to the term “electronic mail” or “electronic message”, the invention is not limited in any way as to the content contained therein. “Electronic mail” includes, but is not limited to, text, audio, visual, video, and digital attachments and any necessary components thereof.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a flowchart that identifies the process of an electronic mail verification request as described herein.

FIG. 2 is a flowchart that identifies the process of an anonymous electronic mail verification request as described herein.

FIG. 3 is a flowchart that identifies the process of identity verification prior to sending an electronic mail by the method and proscribed criteria as described herein.

### DESCRIPTION OF THE PREFERRED EMBODIMENT

Turning now descriptively to the drawings, in which similar reference characters denote similar elements throughout the several views, the attached figures illustrate a certified and registered electronic mail system, which comprises a method, system and process for receiving and sending and registering electronic mail sent over either a computer network, an intranet, the internet, via satellite or other systems that facilitate electronic messaging; and a method, system and process for verifying the identity of an intended recipient of an electronic mail prior to receipt of the email.

The present invention discloses a system, method and process to facilitate three primary functions as follow below.

(i) Registered or Certified Email by an independent authority wherein the originator/sender of the electronic mail is identified. Method one is an independent verification that an electronic mail (including all attachments thereto) was sent to the intended recipient (as identified by the Client) and the time and date of submission (when the electronic mail was sent) and the time and date of delivery to the intended recipient. Verification is a function of the processing unit who sends the electronic mail independent of the Client, albeit on behalf of the Client, who is identified as the sender/originator of the electronic message. Upon delivery to the recipient, the Client shall receive a confirmation of the time and date in the form of a digital certificate;

(ii) Registered or Certified Email by an independent authority wherein the originator/sender of the electronic mail is anonymous. Method two is an independent verification that an electronic mail (including all attachments thereto) was sent to the intended recipient (as identified by the Client) and the time and date of submission (when the electronic mail was sent) and the time and date of delivery to the intended recipient. Verification is a function of the processing unit who sends the electronic mail independent of the Client, albeit on behalf of the Client who is not identified. In this instance, the Processing Unit is identified as the sender of the electronic message only. Upon delivery to the recipient, the Client shall receive a confirmation of the time and date in the form of a digital certificate; and

(iii) Registered or Certified Email by an independent authority wherein the originator/sender of the electronic mail requests that the recipient's identity be verified prior to receipt of the electronic mail. Method three is an independent verification of the recipient's identity (as identified by the Client) by an independent authority prior to the recipient receiving the electronic mail. Per methods one and two above, in this instance, the independent authority (the processing unit) confirms the time and date of submission (when the electronic mail was sent) and the time and date of delivery to the intended recipient. Verification is a function of the processing unit who sends the electronic mail independent of the Client, albeit on behalf of the Client, who may or may not be identified. Upon delivery to the recipient, the Client shall receive a confirmation of the time and date in the form of a digital certificate, and a confirmation that the intended recipient's identity was verified before receiving the electronic mail from the Client.

To achieve the above-identified objectives, the present inventive device utilizes an independent central processing unit (hereinafter the “Processing Unit”) that provides verification of the aforementioned methods. Broadly speaking, the Processing Unit email server interacts with regional email servers and local email servers and with independent local computer networks. Verification requests are tendered through a local computer system to the processing unit via the local and regional email servers. The destination data (the intended recipient) for email communication is acquired from the information described in email data retrieved from the local email server of the customer computer system. When destination data subjected to communication is described in email data retrieved from the email server, the destination data is routed via the processing unit to the intended electronic mail recipient.

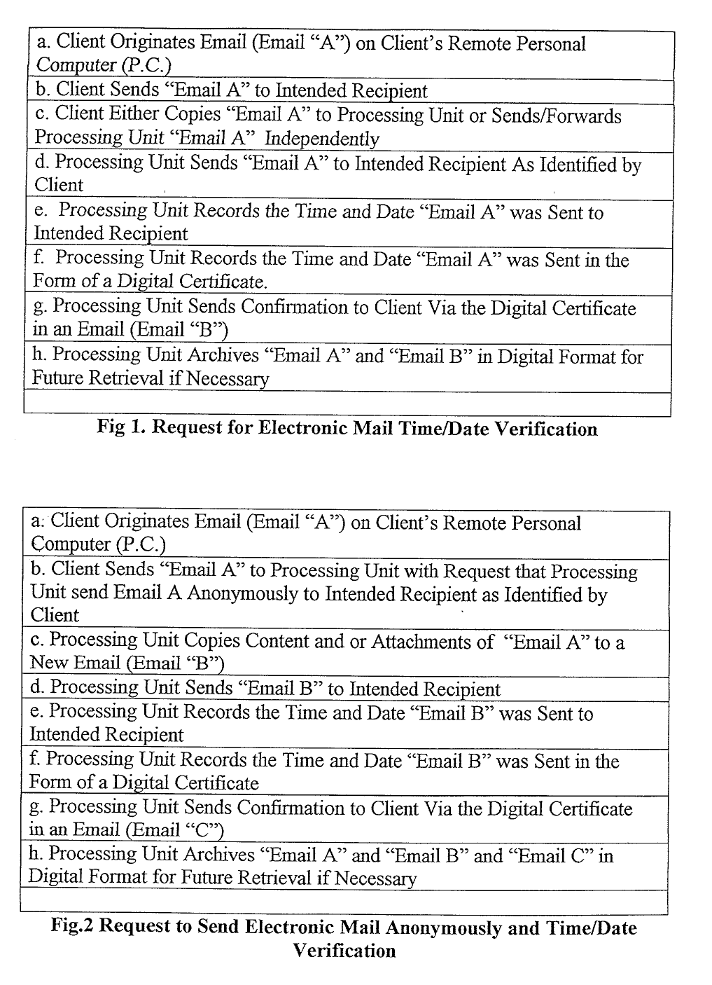

Turning descriptively to the drawings, the Client utilizes the invention in one of three manners as disclosed above. With reference to FIG. 1., a Registered or Certified Email by an independent authority (the processing unit) is depicted wherein the originator/sender of the electronic mail is identified. In this embodiment, the Client (the sender/originator of the electronic mail) sends the electronic mail to the intended recipient independently to the intended recipient. Additionally, the Client sends a copy of the email either independently, or as a “cc” or “bcc” to the Processing Unit. The Processing Unit re-sends the email on the Client's behalf as a registered or certified electronic email message to the intended recipient, as identified by the Client.

Upon sending the electronic mail to the intended recipient on behalf of the Client, the Processing Unit sends the Client a Digital Certificate via electronic mail. The Digital Certificate confirms the date and time that the electronic mail was sent to the intended recipient by the Processing Unit, and the date and time that the electronic mail was received by the intended recipient. The Processing Unit archives the time and date of submission and delivery of original email for future reference. If requested, the Processing Unit archives a copy of the content on the email, including any attachments thereto, for future reference.

With reference to the method and system depicted FIG. 1., in the preferred embodiment, the Client accesses a website on the World-Wide-Web (“WWW”) that is a function of the Processing Unit. The website provides information regarding the services available and the means by which the Client shall be granted access to the present invention. The website provides information regarding the how to utilize the present invention and the means by which the Client's remote computer shall register and submit information to the Processing Unit. The internet and the website thus serve as a point of entrance to the inventive device and the means through which the Client may submit a request for registered email or identity verification. The Client may further submit audio, text, visual or video information to the Processing Unit via the website from the Client's remote computer system.

The Client must register with the Processing Unit to use the service of its choice. The Processing Unit assigns an identification number or code and a password that corresponds to the registration account for future use by the Client and for the tracking of service requests. Upon registration, the Client may submit a registered or certified email request. By way of example, the Client submits a request to send an electronic message containing an attachment in the form of a word document to a designated recipient, via the website and using the Client's local computers system. The Client selects the appropriate service by way of a pull down menu on the website with the available options: registered mail, certified mail, return receipt mail, delivery confirmation, submission confirmation, identity verification, and the like. The Client submits the message, and any attachments thereto, along with the following information: the Client's account information, the Client's name, the Client's email address, the recipient's name, the recipient's email address, the service or services selected, the date the email message is to be sent on behalf of the Client, and any special requests or instructions.

The Processing Unit keeps an internal record of the account request and a copy of the email content (if requested). The Processing Unit submits the electronic message to the intended recipient, as identified by the Client in the registration account, and tracks the submission and delivery cycle of the electronic message. The electronic message clearly indicates that the Client is the originator of the email and that the Processing Unit is an independent authority for registered mail or certified mail confirmation. Upon delivery of the electronic message, the Processing Unit sends the Client a “Confirmation Record”, typically in the form of a digital certificate, of the time and date of the submission and of the delivery of the electronic message. In the event the email message was undeliverable, the Confirmation Record will indicate the attempted delivery time and date. The processing Unit archives the Digital Certificate and the corresponding account information for future use and retrieval.

With reference to FIG. 2, the Processing Unit does not send the electronic mail to the intended recipient on behalf of the Client, even though the Client is the originator of the electronic message. Per the method depicted in FIG. 1, the Client accesses the inventive device via the website, establishes a registration account which is assigned an account name and corresponding code or password by the Processing Unit for internal tracking purposes. The Client submits the electronic message, and any attachments thereto, along with the following information: the Client's account information, the Client's name, the Client's email address, the recipient's name, the recipient's email address, the service or services selected, the date the email message is to be sent on behalf of the Client, and any special requests or instructions.

The Processing Unit keeps an internal record of the account request and a copy of the email content (if requested). The Processing Unit submits the electronic message to the intended recipient, as identified by the Client in the registration account, and tracks the submission and delivery cycle of the electronic message. In this embodiment of the present invention, The Client remains anonymous and the Processing Unit is identified as the sender. The recipient is notified by the Processing Unit that the Processing Unit is acting as a delivery vehicle for an anonymous identity, and that the originator of the message will be notified of the delivery to the recipient. Should the recipient elect, recipient has the option of posting a reply for the originator of the electronic message with the Processing Unit. Upon delivery of the anonymous electronic message, the Processing Unit sends the Client a “Confirmation Record”, typically in the form of a digital certificate, of the time and date of the submission and of the delivery of the electronic message. If the recipient posted a reply for the originator with the Processing Unit, the reply will be contained in the Confirmation Record as well. In the event the email message was undeliverable, the Confirmation Record will indicate the attempted delivery time and date. The Processing Unit archives the Digital Certificate and the corresponding account information for future use and retrieval.

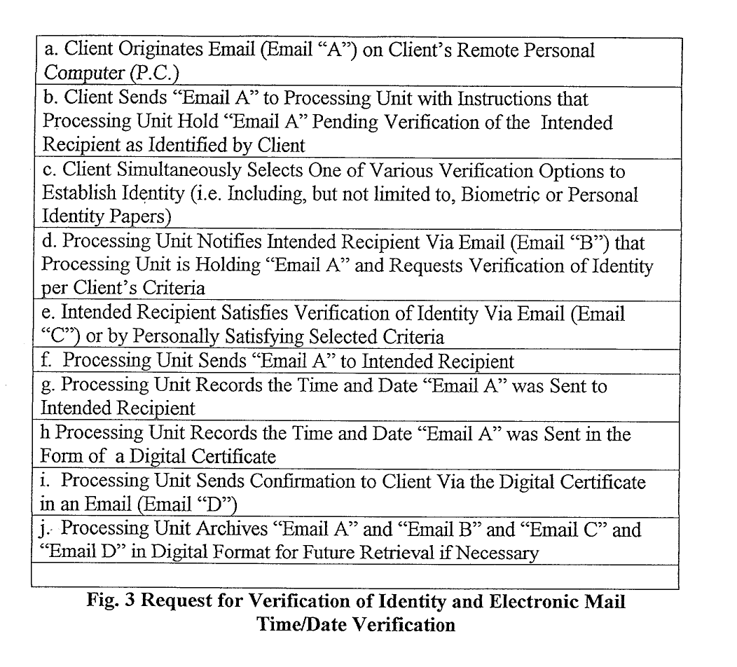

With reference to FIG. 3, the Client may request to have the identity of the intended recipient confirmed prior to the recipient receiving the electronic mail. Per the method depicted in FIG. 1, the Client must register with the Processing Unit to use the service of its choice on the website. The Processing Unit assigns an identification number or code and a password that corresponds to the registration account for future use by the Client and for the tracking of service requests. Upon registration, the Client may submit an identity verification request, along with a registered or certified email request, should the Client require both services.

The Client selects the appropriate service by way of a pull down menu on the website with the available options: registered mail, certified mail, return receipt mail, delivery confirmation, submission confirmation, and the like, along with a request for Identity Verification. Identity shall be established by criteria selected by the sender using a pull down menu on the website. The recipient's identity may be verified by:

(i) having the intended recipient using a predetermined electronic code provided by the Client; or

(ii) having the intended recipient using a predetermined electronic code provided by the Processing Unit;

(iii) having the intended recipient go to a Processing Unit service center for an in-person verification using the intended recipient's personal identification, including, but not limited to, personal paperwork such as a birth certificate, a passport, a driver's license and the like; or

(iv) having the intended recipient provide bio-metric verification; or

(v) other means whereby the intended recipient utilizes a predetermined code, a password or other means of encryption.

The function of the identity criteria is to verify the identity of an intended electronic mail recipient prior to receiving the electronic mail on behalf of the Client, or on behalf of the Processing Unit, should the originator of the email wish to remain anonymous.

With further reference to FIG. 3, per the preferred embodiment, where a request for Identity Verification is submitted, the Client submits the electronic message, and any attachments thereto, along with the following information: the Client's account information, the Client's name, the Client's email address, the recipient's name, the recipient's email address, the service or services selected, the date the email message is to be sent on behalf of the Client, and any special requests or instructions.

The Processing Unit “holds” the electronic mail pending verification of the recipient's identity per the method or means specified by the Client in the corresponding account. The Processing Unit notifies the intended recipient that the Processing Unit is holding an electronic mail for the intended recipient pending verification of his/her identity. The Processing Unit further provides the intended recipient with instructions on how to satisfy the Identity Verification request. The intended recipient may be prompted for a password or code, such as a digital certificate that may be submitted via electronic mail. Alternatively, the intended recipient may be required to provide an in-person verification using personal identity papers, or biometric information, at a stand-alone service center maintained by the present invention.

The Processing Unit keeps an internal record of the account request and a copy of the email content (if requested). Upon personal identity verification, the Processing Unit submits the electronic message to the intended recipient, as identified by the Client in the registration account, and tracks the submission and delivery cycle of the electronic message. The electronic message indicates whether the Client is the originator of the email or whether the Processing Unit is sending the electronic message on behalf of an anonymous entity. Upon delivery of the electronic message, the Processing Unit sends the Client a “Confirmation Record”, typically in the form of a digital certificate, of the time and date of the submission and of the delivery of the electronic message. The Confirmation Record further contains the information used to verify the intended recipient's identity. In the event the email message was undeliverable, the Confirmation Record will indicate the attempted delivery time and date. The processing Unit archives the Digital Certificate and the corresponding account information for future use and retrieval.

In any of the foregoing embodiments of the present invention, the Processing Unit utilizes conventional hardware and software applications. In the preferred embodiment, the main server will be the host server that tracks incoming and outgoing electronic messages; that tracks customer accounts and identities; that archives all relevant information for future use and/or reference; and that disseminates the foregoing data to regional/local servers and clients as necessary. The main server is the central processing unit that serves to receive client account information and to facilitate requests for services and transactions described herein.

Said electronic mail processing system is comprised of the following elements:

(i) an information storage system that will receive the client's account registration information;

(ii) an information storage system that will receive the client's request for certified and registered mail services, and for identity verification services;

(iii) an outgoing mail information system that will track the time and date of when the client's electronic message was sent to the intended recipient;

(iv) an outgoing mail information system that will track the time and date of when the client's electronic message was delivered to the intended recipient;

(v) an information verification storage system that will track notifications sent to the client in the form of a digital certificate that certify the time and date of when the electronic message was sent to the intended recipient;

(vi) an identity verification storage system that will track the criteria used to establish identity and the time and date of notifications regarding the same; and

(vii) an archive information storage system that will track all verifications for future retrieval by the client if necessary.

The main server structurally serves to store all of the information generated by the invention and its related processes, systems, and methods. The main server functions to receive the electronic requests for service from the Client and disseminate the requests to the appending infrastructure (the “head office”) where the request will be processed and packaged to allow tracking of the electronic mail.

The regional server interfaces with the main server. The regional sever in turn receives the information from the main server and disseminate it to the local servers. The regional server receives the electronic mail package from the main server and forwards the electronic mail to the intended local server. The structure and function of the regional server is to interface with the main server and provide tracking information of the electronic mail.

The local servers will in turn disseminate the electronic mail and/or information to the intended recipient. The local server interfaces with the regional server. The local server receives the electronic mail package and forwards it to the intended recipient as identified by the client. The structure and the function of the local server is to interface with the regional server and to provide tracking information of the electronic mail.

The interconnections between the servers include any and all networks and or systems or applications that facilitate the sending and receipt of electronic mail, and any and all infrastructure necessary to facilitate the sending, receipt and confirmation of electronic mail. The various processing systems may also include multiple main frame computers, such as a main frame computer which may be preferably coupled to Local Area Network by means of communications link. Those skilled in the art will appreciate that the main frame computer may be located a great geographic distance from the LAN.

The inventive device is capable of a breadth of applications with respect to certified and electronic mail services. In this vein the following terms, as used herein, shall be construed to have the following meanings:

“Electronic Mail or Email or Electronic Message” are used interchangeably and all denote an electronic message with varied content contained therein. The electronic mail may comprise, but is not limited to, text data, audio data, visual data, video data, electronic data, electronic attachments and any necessary components thereof.

“Registered Email” and “Certified Email” are used interchangeably and denote a variety of services offered by the inventive device. The services may comprise, but are not limited to, registered email, certified email, return receipt email, submission confirmation, delivery confirmation, tracking information and routing information.

“Identity Verification” denotes a variety of services offered by the inventive device. The services may comprise, but are not limited to, verification using digital certificates, biometric information such as a thumbprint, voiceprint, retinal scan, a graphical, hand written signature, or personal identity papers such as a drivers license, a passport, and the like.

“Client” means an individual or entity that tenders a request for services offered by the present invention. The Client may be identified or may remain anonymous.

“Intended Recipient” means an individual or entity as identified by the Client to receive the electronic message. A single electronic may have more than one intended recipient.

With respect to the above description then, it is deemed readily apparent and obvious to one skilled in the art, that all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system and method for registering and certifying an electronic message, said system and method further comprising a client, an intended recipient, a local computer system, a website, a processing unit, an email database, the means to register said electronic message, the system and method comprising the steps of:
said client using said local computer system accessing said website and establishing a registration account;
said processing unit assigning a code to said registration account of said client;
said processing unit receiving said electronic message, said electronic message being from said client;
said processing unit storing information about said electronic message and said registration account in said email database;
said processing unit resending said electronic message to said intended recipient as identified by said Client in said registration account;
said processing unit tracking the date said electronic message was sent by said processing unit;
said processing unit tracking the date said electronic message was received by said intended recipient;
said processing unit creating a confirmation record that comprises said date said electronic message was sent and said date said electronic message was received by said intended recipient;
said processing unit sending said client a copy of said confirmation record; and
said processing unit storing information about said confirmation record and said registration account in said email database.

2. The method of claim 1 wherein said local computer system may be a remote fixed device or a remote portable device; whereby either said remote fixed device or said remote portable device access said website using the internet or other Transmission Control Protocol/Internet Protocol based network connectivity.

3. The method of claim 1 wherein said processing unit further comprises said email database; said email database further comprising an information storage system; said information storage system further comprising the means to store data; said data further comprising said registration account data, said electronic message data, said submission date data, said delivery date data, and said confirmation record data.

4. The method of claim 1 wherein said registration account data further comprises said client's name, said client's email address, said intended recipient's name, said intended recipient's email address, and the email delivery services requested by said client.

5. The method of claim 1 whereby said email delivery services comprise said processing unit sending said electronic message from said client in the form of a registered email, or a certified email, or a return receipt email, or an email submission confirmation or an email delivery confirmation.

6. The method of claim 1 whereby said registered email, said certified email, said return receipt email, said email submission confirmation, and said email delivery confirmation are further comprised of said registration account data and said electronic message.

7. The method of claim 1 whereby said electronic message further comprises varied electronic data, including text data, audio data, visual data, video data, electronic data, and electronic attachments.

8. The method of claim 1 whereby said website further comprises the means for said client to select said delivery services and to submit said electronic message in conjunction with said delivery services to said processing unit from said local computer system.

9. The method of claim 1 whereby said processing unit further comprises the means to receive said electronic message from said local computer system and to send said electronic message to said intended recipient in accordance with said delivery services selected by said client in said registration account.

10. The method of claim 1 whereby said processing unit further comprises the means to determine when said electronic message has been sent to said intended recipient and when said intended recipient has received said electronic message.

11. The method of claim 1 whereby said processing unit further comprises the means to notify said client of when said electronic message was sent to said intended recipient and when said electronic message was received by said intended recipient.

12. The system of claim 11 whereby said processing unit compiles the submission and delivery confirmation data into said confirmation record; said confirmation record further comprising said registration account data.

13. The method of claim 12 whereby said confirmation record is in the form of a digital certificate that is emailed to said client.

14. The method of claim 1 whereby said processing unit further comprises the means whereby a copy of said electronic message is archived and stored for future use and retrieval.

15. A system and method for registering and certifying an electronic message, said system and method further comprising an anonymous client, an intended recipient, a local computer system, a website, a processing unit, an email database, the means to register said electronic message, the system and method comprising the steps of:
said anonymous client using said local computer system accessing said website and establishing a registration account;
said processing unit assigning a code to said registration account of said anonymous client;
said processing unit receiving said electronic message, said electronic message being from said anonymous client;
said processing unit storing information about said electronic message and said registration account in said email database;
said processing unit resending said electronic message to said intended recipient as identified by said anonymous client in said registration account;
said processing unit tracking the date said electronic message was sent by said processing unit;
said processing unit tracking the date said electronic message was received by said intended recipient;
said processing unit notifying said intended recipient that said electronic message has been sent on behalf of said anonymous client;
said intended recipient choosing to post a reply for said client;
said processing unit creating a confirmation record that comprises said date said electronic message was sent to said intended recipient, and said date said electronic message was received by said intended recipient, and said reply posted for said anonymous client;
said processing unit sending said anonymous client a copy of said confirmation record; and
said processing unit storing information about said confirmation record and said registration account in said email database.

16. The method of claim 15 wherein said local computer system may be a remote fixed device or a remote portable device;
whereby either said remote fixed device or said remote portable device access said website using the internet or other Transmission Control Protocol/Internet Protocol based network connectivity.

17. The method of claim 15 wherein said processing unit further comprises said email database; said email database further comprising an information storage system; said information storage system further comprising the means to store data; said data further comprising said registration account data, said electronic message data, said submission date data, said delivery date data, and said confirmation record data.

18. The method of claim 15 wherein said registration account data further comprises said anonymous client's name, said anonymous client's email address, said intended recipient's name, said intended recipient's email address, and the email delivery services requested by said anonymous client.

19. The system of claim 18 whereby said email delivery services comprise said processing unit sending said electronic message from said anonymous client in the form of a registered email, or a certified email, or a return receipt email, or an email submission confirmation or an email delivery confirmation.

20. The method of claim 18 whereby said registered email, said certified email, said return receipt email, said email submission confirmation, and said email delivery confirmation are further comprised of said registration account data and said electronic message.

21. The method of claim 15 whereby said electronic message further comprises varied electronic data, including text data, audio data, visual data, video data, electronic data, and electronic attachments.

22. The method of claim 15 whereby said website further comprises the means for said anonymous client to select said delivery services and to submit said electronic message in conjunction with said delivery services to said processing unit from said local computer system.

23. The method of claim 15 whereby said processing unit further comprises the means to receive said electronic message from said local computer system and to send said electronic message to said intended recipient in accordance with said delivery services selected by said anonymous client in said registration account.

24. The method of claim 15 whereby said processing unit further comprises the means to determine when said electronic message has been sent to said intended recipient and when said intended recipient has received said electronic message.

25. The method of claim 15 whereby said processing unit further comprises the means for said intended recipient to post said reply for said anonymous client.

26. The method of claim 15 whereby said processing unit further comprises the means to notify said anonymous client of when said electronic message was sent to said intended recipient and when said electronic message was received by said intended recipient.

27. The method of claim 15 whereby said processing unit compiles said submission confirmation, and said delivery confirmation data, and said reply posted by said intended recipient, into said confirmation record; said confirmation record further comprising said registration account data.

28. The method of claim 15 whereby said confirmation record is in the form of a digital certificate that is emailed to said client.

29. A system and method for verifying the identity of the intended recipient of a registered or certified electronic message, said system and method further comprising a client, said intended recipient, a local computer system, a website, a processing unit, an email database, the means to verify said identity of said intended recipient, the means to register said electronic message, the system and method comprising the steps of:
said client using said local computer system accessing said website and establishing a registration account;
said processing unit assigning a code to said registration account of said client;
said processing unit receiving said electronic message, said electronic message being from said client;
said processing unit storing information about said electronic message and said registration account in said email database;
said processing unit notifying said intended recipient that said processing unit is holding said electronic message pending verification of said identity of said intended recipient;
obtaining verification information of said identity of said intended recipient;
said processing unit resending said electronic message to said intended recipient as identified by said Client in said registration account;
said processing unit tracking the date said electronic message was sent by said processing unit;
said processing unit tracking the date said electronic message was received by said intended recipient;
said processing unit creating a confirmation record that comprises said date said electronic message was sent, and said date said electronic message was received by said intended recipient, and said verification information of said identity;
said processing unit sending said client a copy of said confirmation record; and
said processing unit storing information about said confirmation record and said registration account in said email database.

30. The method of claim 29 wherein said local computer system may be a remote fixed device or a remote portable device; whereby either said remote fixed device or said remote portable device access said website using the internet or other Transmission Control Protocol/Internet Protocol based network connectivity.

31. The method of claim 29 wherein said processing unit further comprises said email database; said email database further comprising an information storage system; said information storage system further comprising the means to store data; said data further comprising said registration account data, said electronic message data, said submission date data, said delivery date data, said verification information data, and said confirmation record data.

32. The method of claim 29 wherein said registration account data further comprises said client's name, said client's email address, said intended recipient's name, said intended recipient's email address, and the email delivery services requested by said client.

33. The method of claim 29 whereby said email delivery services comprise said processing unit sending said electronic message from said client in the form of a registered email, or a certified email, or a return receipt email, or an email submission confirmation or an email delivery confirmation.

34. The method of claim 33 whereby said registered email, said certified email, said return receipt email, said email submission confirmation, and said email delivery confirmation are further comprised of said registration account data and said electronic message, and said verification information of said identity of said intended recipient.

35. The method of claim 29 whereby said processing unit further comprises the means to notify said intended recipient that said processing unit is holding said electronic message pending confirmation of said verification information.

36. The method of claim 29 whereby said processing unit further comprises the means to notify said intended recipient what said verification information comprises, and the means for said intended recipient to submit said verification information to said processing unit.

37. The method of claim 29 whereby said verification information further comprises a digital certificate, biometric information such as a thumbprint, voiceprint, retinal scan, a graphical, hand written signature, or personal identity papers such as a drivers license, a passport, and the like.

38. The method of claim 29 whereby whereby said electronic message further comprises varied electronic data, including text data, audio data, visual data, video data, electronic data, and electronic attachments.

39. The method of claim 29 whereby said website further comprises the means for said client to select said identity verification services and to submit said electronic message in conjunction with said verification services and in conjunction with said delivery services to said processing unit from said local computer system.

40. The method of claim 29 whereby said processing unit further comprises the means to receive said electronic message from said local computer system and to send said electronic message to said intended recipient in accordance with said delivery services selected by said client in said registration account.

41. The method of claim 29 whereby said processing unit further comprises the means to determine when said electronic message has been sent to said intended recipient and when said intended recipient has received said electronic message.

42. The method of claim 29 whereby said processing unit further comprises the means to notify said client of when said electronic message was sent to said intended recipient and when said electronic message was received by said intended recipient.

43. The system of claim 29 whereby said processing unit compiles the submission and delivery confirmation data into said confirmation record; said confirmation record further comprising said registration account data.

44. The method of claim 29 whereby said confirmation record is in the form of a digital certificate that is emailed to said client.

45. The method of claim 29 whereby said processing unit further comprises the means whereby a copy of said electronic message is archived and stored for future use and retrieval.
